(19) United States
(12) Patent Application Publication
(10) Pub. No.: US 2014/0356977 A1
(43) Pub. Date: Dec. 4, 2014

(54) Method and Apparatus for Performing Automated Affinity Based Assays

(71) Applicant: Endress + Hauser Conducta Gesellschaft für Mess- und Regeltechnik mbH + Co. KG, Gerlingen (DE)

(72) Inventors: Michael Hanko, Dresden (DE); Angela Eubisch, Chemnitz (DE)

(73) Assignee: Endress + Hauser Conducta Gesellschaft für Mess- und Regeltechnik mbH + Co. KG, Gerlingen (DE)

(21) Appl. No.: 14/283,318

(22) Filed: May 21, 2014

(30) Foreign Application Priority Data
May 28, 2013 (DE) 10 2013 105 493.5

(51) Int. Cl. G01N 1/38

(52) U.S. Cl. CPC G01N 1/38
USPC 436/501; 422/69

(57) ABSTRACT

A method for performing automated affinity based assays for determining an analyte content of samples of a process medium, wherein individual samples are fed in time intervals sequentially to a measuring system, and wherein the measuring system, in each case, registers a measured value of a measured variable dependent on the analyte content of the samples, characterized in that at least one of the samples is diluted before it is fed to the measuring system, wherein a dilution factor to be applied for dilution of a sample is ascertained from a measured value registered based on a sample supplied earlier to the measuring system.

The invention relates to a method and apparatus for performing automated affinity based assays for determining an analyte content of samples of a process medium.

In such case, a sample of the process medium is fed, sometimes after pretreatment with one or more assay reagents, to a measuring system embodied to generate a measurement signal representing a measured value of a measured variable dependent on the analyte content of the sample. An automated performance of such assays is done by means of an automated analytical device. Analytical devices with solid phase bound, affinity immunosensors are known, for example, from DE 10 2010 064391 A1, DE 10 2010 064392 A1, WO 2012/055606 A1 and WO 2012/055607 A1.

For quantitatively determining an analyte content, e.g. a concentration of the analyte, in a sample by means of an affinity based assay, it is necessary to be able to describe the relationship between a measurement signal dependent on the analyte content and the analyte content by a mathematical function. This is, as a rule, known for the respectively applied assay (e.g. competitive, non-competitive).

In the case of a competitive assay, the dependence of the measurement signal on the analyte concentration present in the sample can be described, for example, by means of a logistical function having four parameters:

$$Measurement\_signal = d + \frac{( a - d )}{1 + {( {c}_{Analyte} \text{/} c )}^{b}} \qquad ( 1 )$$

wherein the parameter a is the signal in the case of infinitesimal analyte addition, b is the slope at the test midpoint (about 50% signal reduction), c is the test midpoint and d is the minimum sensor signal in the case of analyte excess.

In order to ascertain a calibration function of a competitive assay performed by means of an automatic analytical device, a measurement series with a number of samples of known analyte concentration is run and the above function fitted to the measured values. The inverse function of the so ascertained calibration function gives the analysis function required for calculating the analyte concentration from the obtained measurement signal.

Affinity based assays can be widely applied, since they can be modularly constructed and therewith are adaptable to a wide range of different analytes. Additionally, such assays frequently have a very high sensitivity. In the case of many applications, it is desired to be able, with one and the same measuring principle, to measure over a large concentration range, e.g. over three and more orders of magnitude. An example of such applications is provided by biotech production processes, in the case of which the increase in the product concentration is to be tracked.

For example, the product content of samples, which are taken from a process based on the expression of recombinant, therapeutic, human antibodies in cell culture technology, lies, after inoculating, at some μg/ml and rises during a 14 day to three week fermentation to clearly over 1 mg/ml; this corresponds to a rise of more than 3 orders of magnitude.

In order to determine the product in, respectively product content of, a sample by means of affinity based assays, the sample must, consequently, frequently be prediluted before the measuring, since the typical detection range of affinity based assays lies, most often, at small concentrations and usually covers a concentration range, which is too small, namely, for instance, up to two orders of magnitude. In such case, the accuracy of measurement of the concentration measurement also depends on the dilution being selected not too great and not too small.

It is, consequently, an object of the invention, to provide a method for performing an automated affinity based assay, which yields an improved accuracy of measurement, especially over a large range of analyte contents.

The object is achieved by a method for performing an automated affinity based assay as claimed in claim 1. Advantageous embodiments of the method are set forth in the dependent claims.

In the case of the method of the invention for performing an automated affinity based assay for determining an analyte content of samples of a process medium, individual samples removed from the process medium are fed in time intervals sequentially to a measuring system, wherein the measuring system, in each case, registers a measured value of a measured variable dependent on the analyte content of the samples, wherein at least one of the samples is diluted before it is fed to the measuring system, wherein a dilution factor to be applied for dilution of a sample is ascertained from a measured value registered based on a sample supplied earlier to the measuring system.

The dilution factor is the ratio between the volume of the diluted sample (end volume) and the volume of the undiluted sample (start volume).

The measuring system outputs a measurement signal, especially an electrical measurement signal, dependent on the current measured value of the measured variable. The measurement signal can be evaluated by a control/evaluation system, in order to ascertain the analyte content of the sample.

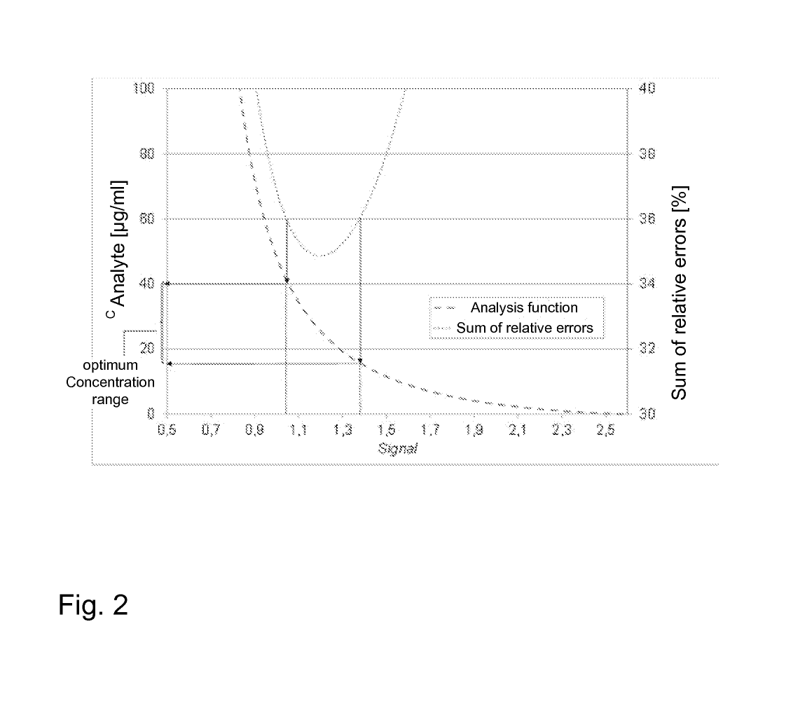

It has been found experimentally that, dependent on the analysis function, a concentration range of the analyte exists in a solution serving as sample, in which relative fluctuations (corresponding to the measurement error) of the measurement signal representing the current measured value lead to a minimum relative error of the analyte concentration determined by means of the analysis function applied to the measurement signal. In other words: dependent on the analysis function, a value range for the analyte content of the sample to be examined can be ascertained, in which the measurement error, with which the registered measured value is burdened, affects only minimally the error of the analyte content ascertained therefrom (compare FIG. 2). It is, consequently, desirable to perform measurements in this optimal measuring range within the detection range. Since a dilution factor to be applied for dilution of a sample is ascertained from a measured value registered based on a sample supplied earlier to the measuring system, the analyte content of the sample can be so adjusted that it lies within the value range, in which the error, with which the analyte content ascertained from the affinity based assay is burdened, is minimal.

Besides this effect of measurement errors constant over the total measurement signal range on the relative error in the case of determining concentration, it is in the case of competitive assay formats supplementally to be recognized that in the case of set analyte concentrations in the sample, which concentrations lie near the test midpoint c of the calibration function (compare equation (1)), the relative errors in the case of determining concentration are smaller than those relative errors, which result in the case of analyte concentrations, which were determined from measurement signal values slightly under the value of a (equation (1)) or slightly over the value of d. The measurement signal value lies near a, when the competitor is present in notable excess compared with the analyte. Correspondingly, the measurement signal value lies near d, when the analyte is present in clear excess compared with the competitor. In both cases, the influence of the respective input concentration errors of analyte and competitor in the sample solution to be measured in the case of registering the measured variable (present in the case of competitive assay in connection with the competitor bound by receptor) gets greater as a function of the excess. Assuming that analyte and competitor have equal affinity for the receptor, at the test midpoint, in contrast, the two ligands are present in the sample solution in the same ratio of one to one, whereby the concentration error of analyte and competitor is not further strengthened and the measured variable is registered with minimal total error. It is, consequently, additionally desirable to perform measurements in the concentration range around the test midpoint.

It is advantageous when the dilution factor to be applied for the sample to be fed next to the measuring system is ascertained from a currently, i.e. latest, registered measured value. It is alternatively or supplementally also possible to take into consideration one or more measured values of older measurements when ascertaining the dilution factor to apply for the next sample.

In an embodiment, the method comprises particularly steps as follows:
feeding a first sample to the measuring system;
registering a first measured value dependent on the analyte content of the first sample;
calculating from the first measured value a dilution factor to apply for a second sample to be fed to the measuring system after the first sample;
diluting the second sample using the ascertained dilution factor;
feeding the second sample to the measuring system; and
registering a second measured value dependent on the analyte content of the second sample.

The first sample can likewise be diluted before feeding to the measuring system based on a predetermined dilution factor. The first measured value can be the last registered, current measured value.

The dilution factor can be calculated, for example, according to specification of a concentration to be expected for the sample and with knowledge of the calibration function, respectively the detection range, for the applied assay.

Additionally, the method can comprise calculating a dilution factor to apply for a third sample to be fed to the measuring system after the second sample based on the first and second measured values, especially by an interpolation method, e.g. a regression method.

The samples can be taken in time intervals sequentially from a process medium contained in a process container, in which a production process is being performed, especially a biological or biotechnological, production process, and in which, at least during a time interval, within which a number of samples are taken from the process container, a concentration of the analyte continuously rises.

Before the samples are fed to the measuring system, one or more assay reagents can be added to the samples, especially after their dilution.

If the process medium is a medium of a process to be monitored, especially a biotechnological process, then, supplementally to the dilution factor, qualitative or semi-quantitative information concerning the process to be monitored can enter into the calculating, since biotechnological processes can be described with the assistance of mathematical models. In the case, for example, of biotechnological microorganism cultures, aspects of the microorganism growth kinetics and aspects of the type of process container, respectively the type of operational guidance of the biotechnological process, enter into a model, which rests, in principle, on the mass balance. Frequently, practically applied operating modes include batch operation, continuous operation and semi continuous (fed batch) operation. These distinctions are based on whether the considered system (in general, this is the process container) is closed (batch), partially open (fed batch) or open (continuous) as regards the liquid phase. Especially in the case of batch operation, the increase of the product concentration passes through a number of orders of magnitude and the microorganism culture shows a characteristic growth curve expressible with mathematical models, e.g. on the basis of so-called MOOD kinetics, wherein frequently a growth coupled product formation occurs. The taking into consideration of such additional information can comprise e.g. the selection and application of an extrapolation function for determining the dilution factor, wherein by means of the extrapolation function the current analyte concentration resulting from the development of the concentration of the analyte in the process to be monitored is predicted based on a last measured analyte content or based on the analyte contents ascertained in a number of measurements performed earlier.

Using the dilution, the analyte content of the sample can be set in such a manner that the error resulting from fluctuations of the measurement signal in the analyte content ascertained based on the measurement signal is reduced in comparison with the error correspondingly resulting in the case of measuring with the undiluted sample.

In an advantageous embodiment, the calculating and the setting of the dilution in the sample occur automatically with the assistance of a bioanalytic measuring system, especially by means of an automatic bioanalyzer, especially one which includes a control/evaluation unit having an electronic data processing system.

The measured values registered based on samples of a process medium during a first process, up to the end of the monitoring of this first process, form a first measurement series. Advantageously, the dilution factors ascertained during the registering of the first measurement series can be stored, e.g. in a memory of the control/evaluation unit of the mentioned bioanalytic measuring system. These can be used in a later registering of measured values based on samples of a process medium of a second process for performing their dilution for ascertaining a corresponding second measurement series. Advantageous in this case is when the time intervals, with which samples are fed to the measuring system and measured values are registered, are identical in the case of the monitoring of both processes and the first and second processes are the same type of processes. In similar processes, type and concentration of the process media agree and the, in given cases, participating microorganisms as well as reaction conditions such as temperature and pressure are essentially the same, so that the dilution factors ascertained for the first measurement series are also applicable for other measurement series to be carried out for similar processes. In this way, the analytical device can learn dilution factors for typical process flows, so that the current dilution factors do not have to be recalculated each time.

An apparatus for performing the method of the invention, respectively a method according to one of the embodiments described here, comprises a control/evaluation unit, which includes an electronic data processing system and a computer program executable by the data processing system for performing the method. The apparatus can further include a sample taking apparatus for removing the samples from the process container, as well as supply lines and transport and metering means, such as e.g. a system of valves and/or one or more pumps, for transporting predetermined volumes of the samples via transport paths formed by liquid carrying lines to the measuring system as well as for delivery and metering predetermined volumes of diluting liquid and, in given cases, of assay reagents to be added to the sample, likewise via transport paths formed by liquid carrying lines, to the sample. The control/evaluation unit can be embodied to control the supply and metering means for performing the affinity assay including the here described method.

The apparatus includes, moreover, the already mentioned measuring system, which has a sensor, which is embodied to register a measured value of a measured variable correlated with the analyte in the sample, in given cases, diluted and, in given cases, containing added assay reagents. This measured variable can be, for example, an intensity of a luminescent radiation or an intensity of a measuring radiation transformed, especially by absorption, after interaction with the analyte or with a reaction product of a chemical reaction transpiring with participation of the analyte. The computer program can be embodied for ascertaining analyte concentrations based on a measurement signal provided by the sensor with application of the furnished analysis function to calculate a value of the analyte concentration.

Furnished in a memory accessible by the control/evaluation unit can be extrapolation functions, which serve for ascertaining a dilution factor taking into consideration additional qualitative or semi quantitative information concerning the process to be monitored.

The computer program can in an advantageous embodiment have a self-learning function for learning dilution factors for bio processes of the same type.

The invention will now be explained based on examples of embodiments illustrated in the drawing, the figures of which show as follows:

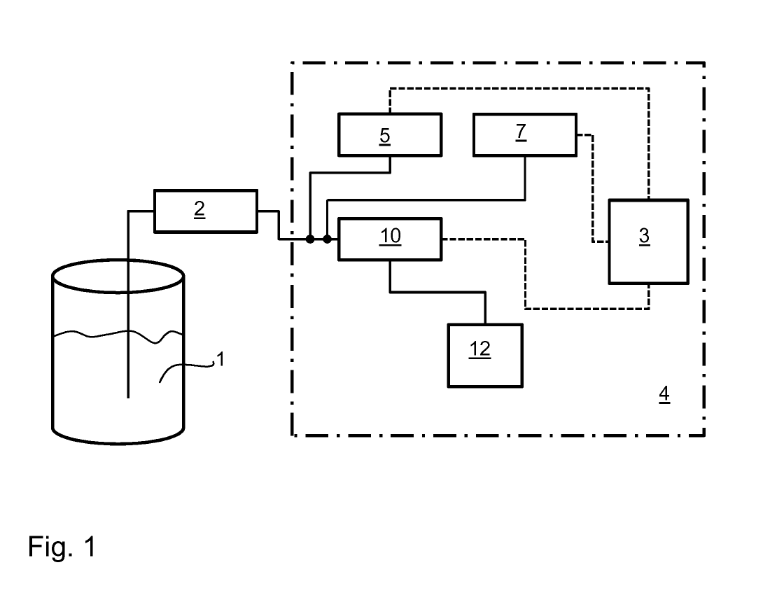

FIG. 1 a schematic representation of an apparatus for performing the method of the invention; and

FIG. 2 a graphical representation of the concentration of an analyte (analysis function) as a function of the measurement signal.

FIG. 1 shows an apparatus 4 for automatic analysis of a sample of a process medium. Apparatus 4 includes a central control/evaluation unit 3, which serves to control the total running of the assay method including the measured value determination. Control/evaluation unit 3 includes a data processing system with one or more microprocessors and data memories as well as, for example, stored in a data memory of the control/evaluation unit, a computer program, which serves the control unit of the apparatus 4 for performing the assay method and the measured value determination.

The process container 1 can be, for example, a fermenter, in which a biotechnological process is performed for producing a product. The analytical apparatus 4 is connected with the process container via a process connection 2, via which samples of a process medium contained in the process container 1 can be taken from the process container 1. The analytical apparatus 4 includes, moreover, a supply container 5 with a liquid used for dilution of the samples. The diluting liquid can be, for example, a buffer, which similarly to the buffer system used for the process medium, minimizes conformation changes of the analyte molecules due to significant changes of the environmental conditions. Apparatus 4 includes, furthermore, an additional supply container 7, in which an assay reagent is contained, which, for performing the assay, can be added to the samples removed from the process container and, in given cases, diluted. Apparatus 4 can, of course, depending on the type of assay to be performed, also contain a number of supply containers for assay reagents. Moreover, the apparatus 4 includes a waste container 12 for used liquids.

The measuring system 10 for determining the product is based preferably on a solid phase bound affinity immunosensor with the properties described in DE 201010064391 A1, DE 102010064392 A1, WO 2012055606 A1 and WO 2012055607 A1. Comprehensive reference to the disclosure of these documents is taken here.

Measuring system 10 is especially embodied to output a measurement signal of a measured variable, whose value depends on the analyte concentration in the sample. For example, the measuring system can comprise, immobilized on a substrate, receptors, to which target molecules to be detected, e.g. the analyte and/or a competitor of the analyte or a conjugate formed from the assay reagent and the analyte, attach through specific interaction. The measuring system can be embodied to register luminescent signals dependent on the concentration of the target molecules bound to the receptors and therewith dependent on the concentration of the analyte in the sample or to register other optical measured variables dependent on the analyte concentration in the sample.

The automatic analytical apparatus 4 includes a number of liquid carrying lines, which connect the process connection 2, the supply container 5 with the diluting liquid and the reagent container 7 with the measuring system 10 and this with the waste container 12. Some or all of these liquid carrying lines are selectively openable and closable by means of valve systems (not shown in FIG. 1). Moreover, the analytical apparatus 4 includes liquid transport means, e.g. pumps or pneumatic or hydraulic pressure means, which serve for transport of samples, diluting liquid, assay reagents and/or waste liquids via the liquid carrying lines. Control/evaluation unit 3 is embodied to control the valves and liquid transport means for delivering the sample, respectively the sample with added liquids, to the measuring system 10, respectively for removing used samples after the measuring from the measuring system 10 into the waste container. This permits complete performance of an automated assay for analysis of an analyte content in samples removed from the process container 1.

For this, for example, before the supplying of a sample to the measuring system 10, its measurement readiness is assured by suitable, completely automatic, method steps, which includes also the successive removal of assay reagent from the supply container 7. Samples of a process medium contained in a process container 1 are taken via a process connection 2 and transported via liquid carrying lines to measuring system 10. The liquid applied for diluting the sample and contained in the supply container 5 is fed to the sample before supplying the sample to the measuring system 10. The sample is, moreover, before delivery to measuring system, supplied assay reagent contained in the supply container 7. All liquids, after accomplishing their tasks, eventually are transported into the waste vessel 12.

Measuring system 10 includes an optical sensor, which can comprise an optical detector, such as e.g. a photodiode or a photodiode array, which is embodied to register chemiluminescent radiation produced by a chemical reaction performed in the measuring system 10 and dependent on the analyte concentration in the sample and to output an electrical measurement signal dependent on the intensity of the registered radiation.

In another embodiment, the optical sensor can have, supplementally to the receiver, one or more light sources, e.g. comprising one or more LEDs, wherein the receiver and the one or more light sources are arranged in such a manner relative to one another that radiation emitted by the one or more light sources, after passing through an absorption measurement cell in the measuring system 10, strikes the receiver. An optical sensor embodied in such a manner can be used for absorption measurements for determining the analyte content, in that the sample, in given cases, diluted and also containing added assay reagents, or a reaction product formed from a chemical reaction with participation of the analyte contained in the sample, is transported into the absorption measurement cell and, by means of the detector, the intensity of the radiation emitted from the light source and dependent on the concentration of the analyte, respectively the reaction product, is registered after passing through the absorption measurement cell and converted into an electrical measurement signal.

Control/evaluation unit 3 is connected with the measuring system 10, in order to control measuring system 10, especially its optical sensor. To the extent that the sensor includes one or more light sources, control/evaluation unit 3 controls the light source for transmitting measuring radiation.

The electrical measurement signal produced by the measuring system 10 and dependent on the analyte concentration of the sample is registered by the control/evaluation unit 3. For determining a measured value of the analyte concentration from the measurement signal, there is furnished in a memory of the control/evaluation unit 3 an analysis function, which, such as described above, is ascertainable by means of calibration measurements. Based on the analysis function, the control/evaluation unit associates a measured value with the registered measurement signal and outputs the measured value to a superordinated system, for example, to a superordinated process controller, and/or or to a display system, e.g. a display.

It was found experimentally that, dependent on the analysis function, there exists for the analyte in the sample to be measured a concentration range, in the case of which the same relative fluctuations of the signal (measurement error) lead to minimum fluctuations in the case of the determined analyte concentration. It is desirable to perform measurements in this optimal measuring range within the detection range. FIG. 2 shows the analysis function in the case of a competitive assay (dashed line). The left y-axis (cAnalyte) gives the function values of the analysis function as a function of the measurement signal. FIG. 2 shows also the curve of the relative error of the concentration (sum relative error; dotted line) as the sum of the same relative positive and negative fluctuations of the measurement signal. The right y-axis (sum relative error [%]) in FIG. 2 gives the values of the relative error. In the example shown here, the measurement error resulting from the positive and negative deviations of the measurement signal amounts to ±5% of the measurement signal. It is clearly recognizable that, in the case of the maximum measurement signal deviation, respectively measurement signal fluctuation of ±5% constant here over the total measurement signal range, measuring signals under 1 and over 1.4 lead to relative errors of the ascertained concentration of greater than 36%. Therefore, the dilution factor is automatically to be set in such a manner that the analyte concentration of the sample currently to be measured lies in the optimal concentration range in the present example of from 18 μg/ml to 40 μg/ml.

Frequently, the qualitative course of the product increase in biotechnological processes is known from earlier experimental work in the development of any given process. If the product, or a substance, whose concentration depends on the product concentration, is the analyte, with the assumption of continuous increase, with knowledge of the process to be monitored and from the previously determined analyte content, the next/future analyte content, e.g. the analyte content probably present in the next measurement (i.e. the analyte content present in the next sample removed from the process container 1 and fed to the measuring system 10), can be predicted, respectively estimated. This can occur, for example, based on the last measured, individual measured value or by an interpolation method based on earlier ascertained values. Serving for this are, for example, the last two registered measured values. Proceeding therefrom, a dilution factor is determined, which is applied to the sample taken then from the process container 1 automatically by supplying diluting liquid from the container 5 to the sample before delivery to the measuring system 10. This dilution factor is then used later as multiplication factor in the determining of concentration. In such case, that dilution is ideally achieved, which leads to measuring in the optimal measurement value range.

Serving for this estimation of the next analyte content and for determining the dilution to apply in the next measuring of the sample is a program furnished in the control/evaluation unit 3. The parameters required for the program, especially extrapolation functions, which preferably take into consideration supplementally qualitative or semi-quantitative information concerning the process to be monitored, can be furnished in a memory, which the control/evaluation unit accesses when executing the program.

The program can be embodied in advantageous manner with self-learning, i.e. that the estimated analyte contents of sequentially taken samples, respectively the dilutions ascertained therefrom, are stored in a memory and used for later measurement series. This is especially advantageous when the apparatus for analysis of a sample liquid is applied regularly for monitoring the same type of bioprocess, especially the same process.

1-14. (canceled)

15. A method for performing automated affinity based assays for determining an analyte content of samples of a process medium, comprising the steps of:
feeding individual samples in time intervals sequentially to a measuring system; and
the measuring system, in each case, registers a measured value of a measured variable dependent on the analyte content of the samples, wherein:
at least one of the samples is diluted before it is fed to the measuring system, and
a dilution factor to be applied for dilution of a sample is ascertained from a measured value registered based on a sample supplied earlier to the measuring system.

16. The method as claimed in claim 15, wherein:
the dilution factor to be applied for the respectively next sample to be fed to the measuring system is ascertained from a currently registered measured value.

17. A method as claimed in claim 15, comprising the steps of:
feeding a first sample to the measuring system;
registering a first measured value dependent on the analyte content of the first sample;
calculating from the first measured value a dilution factor to apply for a second sample to be fed to the measuring system after the first sample;
diluting the second sample using the ascertained dilution factor;
feeding the second sample to the measuring system; and
registering a second measured value dependent on the analyte content of the second sample.

18. The method as claimed in claim 17, wherein:
the first sample is diluted before feeding to the measuring system based on a predetermined dilution factor.

19. The method as claimed in claim 18, wherein:
the first sample is diluted before feeding to the measuring system based on a dilution factor calculated by specification of an expected sample concentration.

20. The method as claimed in claim 17, further comprising:
calculating a dilution factor to apply for a third sample to be fed to the measuring system after the second sample based on the first and second measured values, especially by an interpolation method, e.g. a regression method.

21. The method as claimed in claim 15, wherein:
the samples are removed in time intervals sequentially from a process medium contained in a process container, in which a production process is being performed, especially a biological or biotechnological, production process, and in which, at least during a time interval, within which a number of samples are removed from the process container, a concentration of the analyte continuously rises.

22. The method as claimed in claim 15, wherein:
one or more assay reagents is/are added to the samples, especially after their dilution.

23. The method as claimed in claim 15, wherein:
the process medium is a medium of a process to be monitored, especially a biotechnological process, and
supplementally to the dilution factor, qualitative or semi-quantitative information concerning the process to be monitored enter into the calculating.

24. The method as claimed in claim 15, wherein:
through the dilution, the analyte content of the sample is set in such a manner that the error resulting from the measurement error of the measurement signal is reduced in the determining of the analyte content from the measured value registered by the measuring system.

25. The method as claimed in claim 15, wherein:
the ascertaining of the dilution factor and the setting of the dilution in the sample are performed automatically with the assistance of a bioanalytic measuring system, especially one which includes a control/evaluation unit having an electronic data processing system.

26. The method as claimed in claim 22, wherein:
the measured values registered based on samples of a process medium during a first process form a first measurement series; and
the dilution factors ascertained during the registering of the first measurement series are stored and provided in the case of registering measured values based on samples of a process medium of a second process for performing their dilution for ascertaining a corresponding second measurement series.

27. An apparatus for performing a method of feeding individual samples in time intervals sequentially to a measuring system; and the measuring system, in each case, registers a measured value of a measured variable dependent on the analyte content of the samples, wherein:
at least one of the samples is diluted before it is fed to the measuring system, and
a dilution factor to be applied for dilution of a sample is ascertained from a measured value registered based on a sample supplied earlier to the measuring system, comprising:
a control/evaluation unit, which includes an electronic data processing system; and
a computer program executable by the data processing system.

28. The apparatus as claimed in claim 27, wherein:
the computer program includes a self-learning function for learning dilution factors for bioprocesses of the same type.
